(19) United States
(12) Patent Application Publication
(10) Pub. No.: US 2026/0167770 A1
(43) Pub. Date: Jun. 18, 2026

(54) MOULDABLE COMPOSITIONS

(71) Applicant: DELTA OF SWEDEN AB, Halmstad (SE)

(72) Inventors: Krister THURESSON, Halmstad (SE); Staffan THURESSON, Halmstad (SE); Jonas MODELL, Halmstad (SE)

(21) Appl. No.: 18/996,243

(22) PCT Filed: Jul. 19, 2023
(86) PCT No.: PCT/EP2023/070077

§ 371 Date: Jan. 17, 2025

(30) Foreign Application Priority Data
Jul. 19, 2022 (GB) 2210567.0
Jul. 19, 2022 (GB) 2210572.0

(51) Int. Cl. C08G 63/08; C08K 5/05; C08K 5/109; C08K 9/06

(52) U.S. Cl. CPC C08G 63/08; C08K 5/05; C08K 5/109; C08K 9/06

(57) ABSTRACT

The present invention provides a composition comprising; a) at least one polyester homopolymer or copolymer having a melting point of 40 to 70° C., such as a polycaprolactone; and b) at least one softener, such as a carbonate, benzyl ester or benzoic acid, having a molecular weight of 50 to 500 amu; wherein the composition exhibits a melting point or softening point within the range of 30-45° C. Typically, component a) is present at 25 to 95% by weight of components a) and b); and component b) is present at 5 to 75% by weight of components a) and b). The compositions may additionally comprise a filler. The invention further provides a modelling compound comprising the composition of the invention and a method for the formation of the composition.

### FIELD OF THE INVENTION

The present invention relates to modelling compositions and in particular to modelling compositions which can be solidified into a permanent shape but re-softened to be re-used. Compositions which are safe for use by children are of particular interest.

### BACKGROUND TO THE INVENTION

Different types of modelling clays and the like for producing figures or sculptures have long been known in the art, on the one hand for artistic purposes and, on the other hand as a plaything or educational material for children.

It is known for mouldable or formable compositions to consist entirely of “binder” type materials such as polymers, softeners and other “active” materials or such compositions may comprise an inert “filler” material which serves primarily as a bulking agent. Filled materials can be obtained by providing a coating of a binder on at least one filler, where the filler is formed of particles or grains.

Polymer-based model clays are previously known in the art as a plaything or educational material for children. EP2646996A2 discloses a play modelling dough of composition which is easily malleable and is non-drying so that models can be reformed and the dough can be reused. A drawback inherent in this type of composition is that they are impossible to harden so that, for example, they cannot be used in the construction of, for example, of toys or models to be used or decorated, of landscapes for model railways or as decoration in aquariums etc. U.S. Pat. No. 5,498,645A discloses a mouldable modelling dough composition which does form a solid product upon drying and may be used for some robust items. However, the solidification of the composition is irreversible. Thus the composition cannot be rendered pliable again and cannot be remodeled once dried.

WO2006101440 discloses a material composition that has at least two solid phases, a softer phase being readily deformable at temperatures below the melting point of the binder and a harder phase which can be recycled back to its deformable state. One major drawback of this composition is that the hardened structure can only be attained above the melting point of the binder which is in the range of 60-120° C. As a result, the material must be baked in an oven or heated with the aid of a hot air gun to produce hard figures, which is not only time consuming but is unsuitable for use by children and requires close adult supervision. Another drawback is that if a soft material is once again desired, the hard figures are heated up, where after the composition must be kneaded during cooling in order to become soft at room temperature. Again, this heating step is unsuitable for use by children and the latter working requires lengthy handling of the hot material and takes up considerable time and effort.

Generally, two broad categories of modelling compositions are known; compositions which are intended to stay malleable and those which can be dried or cured to give a permanent shape. The former type remains malleable and can thus be re-used but stays soft and so does not generate a robust, rigid or resilient shape. This type cannot be used to generate permanent or robust objects. The latter type, once formed, can be dried or cured to a rigid or resilient final shape but cannot readily be re-used because the drying or curing process typically cannot or cannot readily be reversed. Furthermore, plastic-type compositions typically require heat to cure and thus cannot be cured by younger children without close supervision.

It would be an advantage to provide a material which can be readily formed or moulded by hand, can adopt a robust or resilient shape and which can furthermore be reused a potentially limitless number of times. It would be a further advantage if all steps could be carried out under conditions sufficiently mild that a young child would not need close supervision to avoid the risk of injury.

There is thus a need in the art to realise a composition principally for play and educational purposes which is readily deformable at room and blood temperature, but can be hardened and recycled at a temperature low enough to be handled by children without the need for excessive working. The composition must also have a low level of adhesion to its surroundings and an attractive and pleasant structure and should be suitable to be handled by children.

The present inventors have surprisingly established a particular class of polymers-based compositions which have a sharp transition between rigid and flexible at around body temperature. Such compositions are thus reformable at temperatures suitable for use by children and form robust materials upon cooling. The materials can be reused without lengthy intervention such as kneading.

### SUMMARY OF THE INVENTION

In a first aspect, the present invention provides a composition comprising;
a) at least one polyester homopolymer or copolymer having a melting point of 40 to 70° C.; and
b) at least one softener having a molecular weight of 50 to 500 amu;
wherein the composition exhibits a melting point (or softening point) within the range of 30-45° C. (e.g. 35 to 40° C.)
wherein component a) is present at 25 to 95% by weight of components a) and b); and
component b) is present at 5 to 75% by weight of components a) and b).

The composition may be a pure polymer/softener composition or may be a filled composition. Thus, in one embodiment the composition additionally comprises;
c) at least one filler.

The softener will typically comprise at least one alcohol; at least one carbonyl; at least one ether; at least one organic acid; at least one halogen; at least one nitro and/or at least one aromatic moiety.

Preferred polymers are caprolactone-based and/or lactide or glycolide based polyesters as described herein.

Preferred softeners include those having at least one benzyl alcohol, benzyl ester, benzyl ether and/or benzoic acyl moiety, including those described herein. Dibenzoate softeners are highly suitable.

In an embodiment, the invention provides a filled composition comprising components a), b) and c) as described above and further described herein.

In a further embodiment, the compositions may include optional component:
d) at least one silicone oil.

In a further embodiment, the compositions may include at least one optional component selected from:
e) a pigment;
f) a glitter;
g) a mica or coated mica;
h) a perfume;
i) a preservative.

In a further aspect, the present invention provides a method for the formation of a composition as described in any embodiment herein, the method comprising:
I) heating component a) to a temperature of 30 to 70° C.,
II) mixing in component b);
III) optionally mixing in components c) and/or components d)-h) where present; and
IV) cooling the resulting mixture to ambient temperature;
wherein steps I), Ili) and III) may take place sequentially or simultaneously.

One example embodiment of this aspect comprises: Heating and mixing components a) and b) together at above the melting temperature of component a) followed by mixing in components c) and/or components d)-h) where present and cooling to ambient temperature.

A further example embodiment of this aspect (where component c is present) comprises: mixing component c) with component b) followed by heating and mixing in component a) and cooling to ambient temperature.

In a further embodiment, the present invention provides a method for forming a 3-dimensional shape comprising;
i) Warming a composition as described herein in water wherein the water is at a temperature of no greater than 42° C. (e.g. 35 to 42° C.);
ii) Forming the composition into the desired shape (e.g. by moulding, pressing extruding, rolling or freehand modelling); and
iii) Cooling the composition (e.g. in ambient air, ambient-temperature water, in cooled air (e.g. in a refrigerator or domestic freezer) or in cooled water such as iced water).

### BRIEF DESCRIPTION OF THE DRAWINGS

FIG. 1 shows the melting temperature of Polycaprolactone copolymer (PCL (90%)-co-PLA (10%)) as increasing quantities of softener are added. The softener used is Dipropyleneglycol dibenzoate and benzoate esters (Benzoflex 988).

### DETAILED DESCRIPTION OF THE INVENTION

The present invention provides a mouldable or malleable composition which can be formed at slightly elevated temperatures but which will become rigid and/or resilient upon cooling to ambient temperature. Such compositions may consist solely of polymer and softener materials (plus optional additives) or may comprise polymer, softener and fillers (plus optional additives).

Component a) of the compositions is at least one polyester polymer, Suitable polymers include homopolymers and/or copolymers and generally will have a melting point of 42 to 70° C. Preferred melting point ranges include 45 to 65° C. or 48 to 62° C. A particularly suitable melting point range is 52 to 63° C. The polymer of component a) will typically have an average (pref weight average) molecular weight of 5 to 200 kD, such as 10 to 100 kD, preferably 25 to 100 or 25 to 50 kD. The polymers of component a) may have a melt flow index of 2 to 100 g/10 min, preferably 3 to 70 g/10 min, such as 5 to 10 g/10 min. MFI will typically be measured according to ASTM D1238 and/or ISO 1133. Typical temperatures for MFI measurement for component a) are 80° C. for polymers of MW below 50 KD (e.g. 35 KD and below, preferably 25 KD and below) or 160° C. for polymers of MW above 25 KD (e.g. above 35 KD, preferably 50 KD and above)

Suitable polymers for component a) include homopolymers and copolymers. Both may be formed or formable from caprolactone monomers. In particular, in one embodiment, the polymer component a) may comprise, comprise essentially of or consist of at least one polycaprolactone homopolymer. In another embodiment, component a) may comprise, comprise essentially of or consist of at least one polycaprolactone copolymer. Such a copolymer will generally be with another polyester material and/or be formed or formable from another ester or alcohol-functionalised organic acid. Suitable alcohol-functionalised organic acids which may form suitable comonomers include lactic acid and/or glycolic acid, or any acid of formula (II) below.

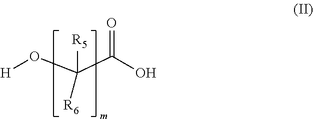

Wherein each of R5 and R6 is independently selected from H; CH₃; C2 to C8 branched or straight chain alkyl or alkenyl groups; and
m is 1 to 8, preferably 1 to 5
lactic acid (m=1, R5=H, R6=CH₃); and
glycolic acid (m=1, R5=H, R6=H)
are preferred examples.

Where a caprolactone copolymer is used, preferably at least 50% (e.g. 50 to 90% or 50 to 95%) by weight of the monomer will be caprolactone with the remainder being one or more other monomers of formula II. Preferably, the caprolactone content will be at least 60% or at least 75%, preferably at least 85%. Correspondingly, the non-caprolactone monomer of formula II may be present in around 2 to 50% by weight, preferably 4 to 30% or 5 to 20% by weight of the polymer.

A preferred homopolymer is caprolactone homopolymer. In one embodiment, component a) may comprise, consist essentially of or consist of at least one caprolactone homopolymer.

A preferred copolymer is a copolymer of caprolactone and lactide (e.g. 60 to 95% caprolactone and 5 to 40% lactide by weight). In one embodiment, component a) may comprise, consist essentially of or consist of at one least copolymer of caprolactone and lactide.

The polyester homopolymer or copolymer for use as component a) in all aspect of the invention may have any suitable molecular weight. Typical number average molecular weights may be 3,000 to 200,000, preferably 10,000 to 120,000 or 20,000 to 100,000. In one embodiment, a polymer of MW around 40,000 to 80,000 is used.

The polymer component a) will typically be present in an amount of at least 25% by weight of components a) and b). This may be, for example, 28% to 95%, 30 to 70% or 32 to 65% by weight of components a) and b).

For both homo-polymers and co-polymers in all aspects of the invention, the terminal ends of the polymers may be substituted with any appropriate functionality. This may be in order to modulate properties or reactivity of the polymer or may be the result of the polymerisation process. In particular, at least one end of the polymer chain may include the remnant of any suitable initiator. Common initiator remnants include alternative esters (e.g. esters of diols such as C2-C8 diols). These will be particularly common at the acid end of the polyester chain. Diols of particular utility as initiators include ethylene diol, propylene diol and butylene diol or pentylene diol. A butylene diol ester at the terminal end of the polyester is particularly common.

The compositions of all aspects of the invention include a softener component b). Such a softener may be any suitable material that serves to reduce the melting point (or melting point range) of the polymer component a) such that it meets the range discussed herein. Suitable softener materials typically comprise at least on functional group, especially at least one oxygenated functional group. Suitable softeners will typically comprise at least one alcohol, at least one carbonyl (e.g. carbonate, ketone, aldehyde or ester); at least one ether; at least one epoxide, at least one organic acid, at least one halogen, at least one nitro and/or at least one aromatic moiety. Many aromatic moieties are suitable but benzyl groups are typically effective. Terephthalate groups comprise “benzoic acid” type functionality and are also highly suitable, particularly in the form of esters, such as diesters with C2 to C12 alkyl alcohols.

Alcohols including poly-ols can form effective softeners as all or part of component b). These can include C2 to C12 diols and oligomers of diols (such as di- or tri-ethylene glycol or di- or tri-propylene glycol). Diols may be esterified with one or two organic acids (especially C2 to C12 alkyl organic acids) to give mono- or di-esters.

Organic acids, including di-acids (such as C2 to C12 organic di-acids) may also form suitable softeners and may be used as the free acids, as mono- or di-esters with suitable alcohols (e.g. C2 to C12 alkyl alcohols or diols) or as oligomers with C2 to C8 alkyl diols such as ethylene glycol or propylene glycol. Fatty acids such as C6 to C20 fatty acids and their esters (e.g. with C2 to C6 alcohols including diols and polyols such as glycerol) may also be used.

“Carbonates” (compounds having a carbonate ester moiety), such as propylene carbonate, may also form suitable softeners as all or part of component b). Suitable carbonates include cyclic or linear alkyl and/or aryl carbonates such as cyclic alkylene carbonates (e.g. C2 to C12 cyclic carbonates), linear alkyl carbonates such as R₅—O—CO—O—R₆ where R₅ and R₆ are independently C1 to C12 linear branched alkyl groups or aryl carbonates such as R₇—O—CO—O—R₈ where R₇ and R₈ are independently C5 to C10 aryl or heteroaryl groups such as phenyl groups. Dicarbonates such as C2-C12 dialkyl decarbonates (e.g. dimethyl dicarbonate or diethyl dicarbonate) may also be suitable. Examples of suitable carbonates include diphenyl carbonate, ethylene carbonate, trimethylene carbonate, dimethyl decarbonate, propylene carbonate and mixtures thereof. A preferred carbonate is propylene carbonate.

In a preferred embodiment, component b) may comprise or consist of at least one carbonate. In a further preferred embodiment, component b) may comprise at least one carbonate in addition to another softener, such as a benzyl ester (e.g. as described herein).

In one embodiment, the softener may comprise at least one benzyl alcohol, at least one benzyl ester, at least one benzyl ether and/or at least one benzoic acyl moiety. All aromatic moieties, including the benzyl moieties may be optionally substituted with a least one alcohol, at least one carbonyl, at least one ether, at least one organic acid, at least one halogen, and/or at least one nitro moiety. Alkyl and/or alkenyl groups may also form substituents on any of the aromatic moieties including benzyl moieties. Suitable alkyl and/or alkenyl groups may include, for example, straight, branched or cyclic C1 to C12 alkyl and/or alkenyl groups, preferably C1 to C4 alkyl and/or alkenyl groups. Evidently, alkenyl groups will have a minimum of 2 carbons and cyclic groups a minimum of 3 atoms in the ring.

One highly suitable component, which may form all or part of component b) is a dibenzyl moiety, preferably a dibenzyl ester linked by a polyalkylene oxide chain. Suitable compounds include at least one compound selected from those of formula (i) below:

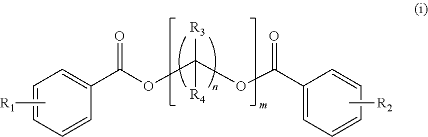

wherein:
each of R₁ and R₂ is independently selected from H; Cl; F; Br; NO₂; CH₃; C₂ to C₈ branched or straight chain alkyl or alkenyl groups;
each of R₃ and R₄ is independently selected from H; Cl; F; Br; CH₃; C₂ to C₈ branched or straight chain alkyl or alkenyl groups;
m is an integer value between 1-10;
and n is an integer value between 1-10;
In one preferred embodiment, each of R1 and R₂ is independently selected from H; CH₃; C2 to C4 branched or straight chain alkyl or alkenyl groups.

In a further embodiment, each of R3 and R4 is independently selected from H; CH₃; and C2 to C4 branched or straight chain alkyl.

In a further embodiment, at least one of R3 and R4 is H, preferably each of R3 and R4 is H.

In a further embodiment, m is an integer value between 2-3.

In a further embodiment, n is an integer value between 2-3.

The softener component b) will typically be present in an amount of up to 75% by weight of components a) and b). This may be, for example, 5 to 75%, 30 to 70% or 35 to 68% by weight of components a) and b).

The softer component b) will typically have a boiling point high enough to prevent high loss of the softener through evaporation. In one embodiment, the softener may have a boiling point of greater than 150° C. (e.g. 150 to 1000° C.), preferably greater than 200° C. or greater than 220° C.

The compositions of the present invention (along with all aspects thereof) may include a filler material. The filler is distinct from the “binder” materials of components a) and b) in that it need not have a controlled melting point. The composition will soften when the binder material softens but that binder material may contain inert filler material that need not take part in such a transition in order for the overall composition to become malleable. The filler component is referred to herein as component “c)”.

Where filler component c) is present, this is at least partially coated and encapsulated by components a) and b)

Fillers (component c)) may be any suitable inert material but will typically be a particulate material. Suitable materials include sand, glass and other “inorganic” materials such as minerals; and polymers including natural, semi-synthetic and synthetic polymers. Natural polymers may include polyphenol and polysaccharide based fillers including lignin and cellulose type fillers such as wood dust, as well as carbohydrate type fillers such as wheat flour, rice flour or corn flour. Synthetic polymers include polyolefins (e.g. polystyrene, polyethylene or polypropylene), polyesters (e.g. polyethylene terephthalate (PET), polybutyrate), polyamide, polyurethane etc. as well as mixtures thereof. Expanded materials including hollow glass microspheres and expanded polymers (polymer foams) such as foam latex, polyurethane forms, expanded PVC, expanded polystyrene or expanded polyethylene and copolymers comprising any of these. One particularly suitable expanded material is “Expancel”, a copolymer of vinylidene chloride, acrylonitrile and methyl methacrylate, typically formulated with isobutene as a blowing agent.

In one embodiment, the filler material may be a biodegradable material such as a polyester (e.g. polylactide). In such cases, the filler polyester will typically have a melting point higher than that of the binder components a) and b) when combined. For example, the filler may have a melting point of 50° C. or greater (e.g. 50 to 200° C.). Poly lactide polymers, polyglycolide polymers or lactide/glycolide copolymers are suitable examples. Such polymers may be used as solid polymer particles or as expanded foam particles such as expanded foam beads. Such expanded beads may be formed using known methods such as use of alkane, air or CO₂ blowing agents. BioFoam from BEWI is one example of a suitable polyester foam filler. Particle sizes may for such foams may be any of those indicated herein, such as 0.5 to 5 mm.

Generally, the filler material will have a melting point of greater than the melting point of the binder material. Some fillers (e.g. glass or mineral fillers) will not melt at realistic use conditions but polymer fillers (especially synthetic polymer fillers) will generally have a melting point or decomposition temperature of at least 70° C. (e.g. 70 to 500° C. such as 70 to 150° C.).

Typical examples of filler component c) include a sand filler, a glass filler, a polymer filler, a mineral filler or mixtures thereof. Typical sand fillers include quartz sand and/or a silica sand. Such “sand” may therefore include course sand or gravel sized particles. Typical “sand” as indicated herein will be of average particle size 50 μm to 5 mm (e.g. 63 μm to 5 mm), preferably 95 μm to 3 mm, but sand may also encompass gravel and small pebble-size fillers of average particle sizes up to around 10 mm, which may also be used. When referring to an individual particle, sizes are generally the smallest diameter (i.e., the diameter in the smallest axis). Sand fillers (and all other fillers) may be “bimodal” or “polymodal” in that more than one size of filler may be present. For example, a fine sand or silica filler with average particle size less than 100 μm may be used in combination with a course “sand” or gravel filler of particle size 1 mm or larger (e.g. 1 to 10 mm). Such a bimodal mixture of fillers allows for better coating of the larger particles and may improve the properties of the binder. Typically in such cases, where the fillers particles of the two sizes have similar density (e.g. ±50%) the filler component c) will comprise at least 60% by weight of the larger size filler, preferably at least 75% by weight.

A highly suitable “small” filler is finely powdered calcium carbonate or silica. Such a filler does not have a significant effect on the texture of the material but serves to increase the bulk of the binder components. Finely powdered fillers (“small fillers”) of this type may have an average particle size of below 20 μm (e.g. 0.5 to 20 μm), preferably below 10 μm (e.g. 1 to 10 μm). An average particle size of 0.5 to 8 or 2 to 20 μm is highly suitable for such small fillers, which may be formed of any filler material disclosed herein, particularly inorganic fillers such as silica or calcium carbonate. Such small filler particles may form the only filler but may also be used in combination with a larger filler material. All ranges of filler content discussed herein are appropriate but around 10 to 50% by weight of all components in the composition is a preferable range for the small filler particles, particularly 20 to 40% by weight.

Silica fillers, particularly hydrophobised silica fillers, form a highly preferred mineral filler for use as a “small filler”, forming at least a part of component c) of the present invention. Such fillers may be added in an amount of around 1 to 30% by weight of all components in the composition. When this pre-filled composition is then added to a larger quantity of another filler (see below for typical filler quantities) the small filler has the effect of increasing the volume and potentially also the binding effect of components a) and b) without requiring more polymer, or softener.

In one advantageous embodiment, the various products of the present invention may include both a “small filler” such as hydrophobised fumed silica filler or a small particle calcium carbonate filler and a second filler of any of the types indicated herein. This provides advantages to the elasticity and robustness of the binder, especially when the small filler (e.g. hydrophobised fumed silica filler) is employed at a level of around 5 to 30 wt % (e.g. 10 to 25% or 5 to 15%) relative to the total of that filler and components a) and b). Preferred hydrophobised fumed silica fillers may comprise various particle sizes including aggregates of small particles. Typical aggregated fumed silica particles may be in the range 1 to 100 μm, preferably around 5 to 50 μm in smallest dimension.

All fillers, especially mineral fillers including glass, sand, silica, alumina and other mineral fillers, may be surface-treated. Many useful surface treatments exist to improve various properties such as performance and/or appearance. One preferred surface treatment is hydrophobic surface treatment to “hydrophobise” the surface of the filler. Surface-treated (e.g. hydrophobised) glass, sand, silica and/or alumina thus form preferred fillers in the present invention. Suitable surface treatment, particularly for silica-containing fillers, may include treatment with alkoxy silanes or silyl alkanoates at 0.05 to 0.2% by weight of the filler.

Glass fillers useful as component c) of all aspects of the present invention include crushed glass fillers, glass sphere fillers, a hollow glass sphere fillers and mixtures thereof. Average particle sizes will preferably be around 10 μm to 2 mm, although crushed glass fillers may comprise very small particles, such as down to 1 μm and smaller.

Certain mineral fillers are highly advantageous as all or a portion of component c) in all aspects of the present invention. Such mineral fillers include sand (as discussed above), silica fillers, titania fillers, alumina fillers, calcium carbonate fillers, calcium sulphate fillers, sodium sulphate fillers, silicate compounds, kaolin and other clays, calcium phosphates, talc and mixtures thereof.

Polymer fillers may include any compatible natural, semi-synthetic or synthetic polymer in any appropriate form. Synthetic polymer fillers include, for example, polyolefin (e.g. polystyrene, polyethylene, polypropylene), polyester, and/or polyamide fillers including beads, shavings, polymer saw-dust, cut films or any other suitable particles of such materials. Preferred filler particles are beads and synthetic polymer fillers may comprise polystyrene beads, other polyolefin beads, polyester beads and/or polyamide beads. Such polymer fillers may be in the form of solid pieces, or may be formed into expanded open- or closed-cell foams by methods well known in the art. Such “expanded” materials make excellent fillers, particularly where a light or insulating material is desired. Such light materials include hollow spheres of any of the polymers indicated here as well as “expanded” foamed materials including expanded polystyrene, expanded polyolefin, expanded polyester, expanded polyamide, expanded PLA (poly lactide) and mixtures thereof, typically in the form of foam beads. Polymer filler particles may vary in size from around 50 μm up to several mm (e.g. up to around 10 mm) in diameter. In general, unexpanded or unfoamed fillers will typically be of smaller particle sizes (such as 50 μm to 1000 μm, preferably 100 μm to 500 μm) and expanded or foamed fillers will typically be of larger sizes, such as 200 μm to 10 mm, preferably 300 μm to 5 mm). As with other particle sizes indicated herein, the sizes stated typically refer to the smallest dimension, where context allows.

Polymer fillers may also comprise or consist of natural polymers such as polysaccharides including starches, chitin and cellulose, as well as other natural polymers such as polyphenols (e.g. lignin) and proteins (e.g. keratin). Polysaccharides are particularly suitable and may be in the form of, for example, flours ground from natural materials such as grains (e.g. wheat, maize, rice) or as flour, dust or chippings from wood, bamboo or other fibrous materials. Natural materials may also be “expanded” by heating to generate materials such as pop-corn, puffed wheat or crisped rice. Steam expansion or steam explosion may also be used. Such materials may also be used as fillers of the present invention, either in their natural, large particles, or ground, or cut into smaller particles. Natural polymers are typically very non-toxic and safe to use and are highly useful in embodiments of the present invention which may be used by children. Sawdust and fine wood chippings, wheat, maize, wood and rice flours are preferred natural polymer fillers. Charcoal from natural sources may form both a filler material and a black colourant in the various materials of the present invention.

The total amount of filler in the compositions of the present invention may vary from around 1% to 99.5% of component c) by weight of the total composition. In practice, there are two sub-ratios which are most likely to be used depending upon the types of filler in use and the density of that filler. For non-expanded fillers (e.g. with a density greater than 0.5 g/cm³) the total amount of filler may vary from around 10% to 99.5% of component c) by weight of the total composition. Preferably, the ratio of components a) & b) to c) in the total of all components will be around 2 to 30% by weight binder and 70 to 98% by weight filler in the overall composition. For expanded fillers, (e.g. those with a density of less than 0.5 g/cm³), the content may typically be around 1% to 90% component c), more preferably 2% to 50% component c) by weight. In addition to the weight ratio, it is also important to maintain a suitable volume ratio because there is a maximum volume of filler that can effectively be coated by a certain amount of binder. The volume ratio of filler (component c)) to binder (components a) and b)) should therefore not be greater than around 500:1, preferably no greater than 200:1, filler volume:binder volume. Common ratios may be between 100:1 and 1:1, such as between 50:1 and 2:1 or 40:1 and 5:1.

Optional component d) is applicable to all aspects of the present invention and relates to a silicone fluid (silicone oil). Such a silicone fluid will generally be a linear, branched and/or cyclic oilgo- or poly-alkylsiloxane with or without at least one hydroxyl termination. Poly- or oligo-dimethylsiloxane forms a preferred example, with or without at least one hydroxyl termination.

Suitable silicone fluids may have viscosities over a broad range, such as viscosity 1 to 5000 mPas at 25° C. This will preferably be around 2 to 2500 mPas at 25° C. (e.g. 2 to 150 mPas at 25° C.). Molecular weights of suitable oligo- or poly-alkylsiloxanes may vary from around 100D to around 50 kD, such as around 0.2 to around 30 kD or 0.2 to 5 kD. Polydimethyl siloxanes (PDMS) are highly appropriate, with any terminal group (including hydroxy-terminated and/or non-hydroxy terminated PDMS).

Some examples of useful silicone fluids include CDS100 (linear polydimethylsiloxane Hydroxyterminated at both ends with a molecular weight of about 4 kD and a viscosity of about 100 mPas at 20° C.), AK5 (low molecular weight oligo dimethylsiloxane without hydroxytermination, viscosity around 5 mPas at 25° C.), AK10 (Wacker, polydimethylsiloxane without hydroxytermination MW around 1100D) and POLYMER C 2 T (Wacker, linear polydimethylsiloxane, hydroxyterminated at both ends with a molecular weight of about 25000 with a viscosity of about 2000 mPas 25° C.).

Component c), where present, will typically be present in an amount of no more than 20% by weight of the total composition (e.g. 0.5% to 20%). This will preferably be 1 to 15% or 3 to 12% by weight (e.g. 5 to 10%). Relative to binder components a) and b), the amount of silicone oil (where present) may be up to around 15% (e.g. 0.1 to 15% by weight), preferably 1 to 12% such as 2 to 10% by weight of components a) and b).

In all aspects of the present invention, the products and compositions may comprise at least one of various optional components such as;
e) a pigment;
f) a glitter;
g) a mica or coated mica;
h) a perfume;
i) a preservative; and/or
j) a fire-retardant.

Each optional component provides advantages which are useful and valuable in certain embodiments and certain applications and may be selected independently and used individually or in any combination where technically feasible. The various components are described herein separately for clarity but may be used in combination to provide desirable properties to the compositions of the invention.

Examples of each of these additives are well known to the skilled worker and many are exemplified herein. In preferred embodiments, these optional components may be any of those set out in the Examples section herein and particularly in the “Table of chemicals used in the examples” which precedes the worked examples. Glitter, as referred to herein includes plastic film based glitter (e.g. polystyrene film glitter).

Additional components e) to j) or other additional components, where present, will each typically be present at no more than 5% by weight (e.g. 0.01 to 5%) of the total composition. This will preferably be no more than 2% or no more than 1% by weight.

The present invention additionally provides for a method of forming a 3-dimensional shape utilising the compositions described herein. Such a method will preferably require only very mild conditions such that this can be conducted by persons of all ages with little risk and only minimal supervision. In general the compositions of the present invention are formulated to soften at or around body temperature such that they can be heat-softened and handled in their softened state without risk of burning injury. Water is a highly effective medium for heat-transfer and may be used for this purpose. Warmed water may be provided in, for-example, a low-power thermostatic heating bath and so be maintained at a safe temperature which is sufficient to soften the compositions. Suitable temperatures will be no more than 45° C., preferably no more than 42° C. (e.g. 35 to 42° C.).

Correspondingly, the compositions of the invention have a melting point (softening point where, for example, the filler prevents easy assessment of the melting point) of 30 to 40° C., such as 35 to 40° C. or 36 to 39° C. Melting point can be assessed using a standard “hot stage” method. In all appropriate embodiments and especially where compositions are not readily assessed for melting point (e.g. because of the presence of solid fillers) “melting point” as used herein may be taken to mean “softening point”. Any appropriate measurement of such softening point may be used, such as preparing a 100×10×3 mm bar of the composition and cooling to room temperature, then supporting the bar 1 cm from each end at a controlled temperature and measuring the temperature at which the bar sags in the centre under gravity by 5 mm or more. The test is relatively independent of bar thickness and so where large fillers are used a bar of the thickness of at least two filler particles may be used.

The composition may be repeatedly heated and formed until a final form is created, at which point the composition can be cooled. Cooling may be simply by leaving the 3-d shape in ambient air or cooled air (e.g. in a refrigerator or domestic freezer) or by immersion in ambient or cooled water. Iced water will serve to essentially instantly “set” the compositions of the invention. Rapid solidification may also be achieved in a refrigerator or domestic freezer.

In one embodiment, the compositions of any aspect or embodiment of the present invention remain mouldable at suitable temperatures (e.g. 35 to 42° C.). The compositions of the present invention preferably do not “set” or “cure”. That is to say, the compositions of the present invention do no form a rigid material which cannot be reshaped by hand at a suitable temperature (e.g. 35 to 42° C.).

As used herein, the term “about”, “around” “substantially” or “approximately” in relation to a number or a range of numbers will generally indicate that the number or range specified is preferred but that such a number may be varied to a certain extend without materially affecting the properties of the relevant material, composition or similar product. The skilled worker will typically be able to readily establish the extent by which such numbers may be varied without prejudicing the key advantages of the present invention. As a general guide, such numbers or the ends of such ranges may be varied by +10%, preferably +5% and more preferably +1%. A corresponding meaning may be attributed to compositions “consisting essentially of” certain components, which may include up to 10%, preferably up to 5% and most preferably up to 1% of other components in addition to those specified. Where a chemical group, chain or other moiety is described herein as optionally substituted, such substitution may be absent or one or more atoms in the moiety (typically one or more hydrogens and/or carbons) may be substituted with groups such as halide (e.g. F, Cl, Br, I) groups, oxygen-based moieties such as ethers, alcohols, esters carboxylic acids or epoxides, nitrogen-based groups such as amines, amides, nitriles or nitro groups, or sulphur-based groups such as thiols, disulphides, thioesters etc. Up to around 10 such substitutions may be made where context allows, but typically 3 or few substitutions, such as 1, 2 or 3 substitutions with independently selected substituent groups will be typical.

### EXAMPLES

The examples show that standard grade polycaprolactone polymer and also the co-polymers can be used effectively in the present invention. We obtained a composition with robust, reproducible, and controlled properties by combining polymer and softeners. The softener addition can be used to control and adjust the properties in a reproducible way.

### Materials and Properties

TABLE 1
Various softeners that have been used in the examples.

| Commercial name | Chemical name/description | Abbreviation |
|---|---|---|
| Eastman Benzoflex | Reaction mass of Diethylene glycol dibenzoate, | Benzoflex 2088 |
| 2088 | Diproplyene glycol dibenzoate and Triethylene | |
| | glycol dibenzoate | |
| Eastman Benzoflex 988 | Dipropyleneglycol dibenzoate and benzoate esters | Benzoflex 988 |
| Eastman168 | Bis(2-ethylhexyl) terephthalate | Eastman168 |
| Eastman TX1B | 2,2,4-trimethyl-1,3-pentanediol diisobutyrate | Eastman TX1B |
| Eastman TEG-EH | Triethylene glycol bis(2-ethylhexanoate) | Eastman TEG-EH |
| Emery Edenol102 | PEG ester | Edenol102 |
| Emery Edenol1212 | Adipic acid based plasticier | Edenol1212 |
| Emery Edenol1215 | Adipic acid based plasticizer/polyadipate | Edenol1215 |
| Emery Edenol DBS | Dibutyl sebacate | Edenol DBS |
| Emery Edenol1200 | Adipic acid based plasticizer/polyadipate | Edenol1200 |
| Emery Edenol D81 | Epoxidised soya bean oil | Edenol D81 |
| Emery MC2192 | Polymeric biobased and biodegradable softener | MC2192 |
| DuPont Danisco SnS | Acetic acid ester of monoglycerides made from | SnS |
| | fully hydrogenated castor oil | |
| Sasol Isofol20 | Octyldodecanol | I20 |
| UBE Corporation DMC | Dimethyl Carbonate | DMC |
| UBE Corporation PC | Propylene Carbonate | PC |

TABLE 2
Various fillers that have been used in the examples.

| Commercial | | Density | | |
|---|---|---|---|---|
| name | Chemical name/description | (kg/m3) | Particle size | Abbreviation |
| Symbra | Expanded polylactide | Ca. 25 | Ca. 3.5 mm | E-PLA |
| Technology | | | | |
| BioFoam | | | | |
| Expancel 461 | Pre-expanded hollow polymer | Ca. 25 | d50 ca. 40 | Expancel 461 |
| DET 40 d25 | based compressible particles. | | micrometer | DE |
| | (Acrylonitrile/Methyl | | | |
| | Methacrylate/Vinylidene | | | |
| | Chloride Copolymer, Isobutane) | | | |
| Expancel 461 | Expandable polymer based | — | — | Expancel 461 |
| DUT 40 | particles. | | | DU |
| Wacker HDK | Synthetic, hydrophobic, | Ca. 200 | d50 ca. 10 | HDK H2000 |
| H2000 | amorphous silica. Trimethylsiloxy | | micrometer | |
| | surface treatment | | (agglomerate size) | |
| Ionian Kalk | Surface treated high purity | 1250 | d50 ca. 4 | Iokalit A |
| Iokalit A | natural chalk (CaCO3) | | micrometer | |
| Sibelco Sand | 98.8% SiO2 | 1500 | d50 ca. 91 | GA39 |
| GA39 | | | micrometer | |
| Sibelco Sand | 99.5% SiO2 | 1500 | d50 ca. 270 | M32 |
| M32 | | | micrometer | |
| Sibelco Sand | 90.5% SiO2 | 1500 | d50 ca. 500 | B55 |
| B55 | 4.9% Al2O3 | | micrometer | |
| Sand | Surface treated SiO2 | 1500 | d50 ca. 91 | GA39(ST) |
| | | | micrometer | |
| Sand | Surface treated SiO2 | 1500 | d50 ca. 270 | M32(ST) |
| | | | micrometer | |
| Sand | Surface treated SiO2 | 1500 | d50 ca. 500 | B55(ST) |
| | | | micrometer | |

TABLE 3
Various piments and additives that have been used in the examples.

| Commercial | | Characteristic | |
|---|---|---|---|
| name | Chemical name/description | property | Abbreviation |
| BASF Microlen | Mixture, mainly consisting of a | pigmentation | Microlen(‘color’) |
| | pigment and a polyethylene | | |
| | (PE) carrier/various colours | | |
| Radiant Radglo | Dyed, pigmented thermoplastic | Fluorescent | GWT(‘color’) |
| GWT | polyester amide copolymer/ | pigmentation | |
| | various colours | | |
| Ferro Lysopure | C.I. Pigment Red 170 | Pigmentation/dye | Lysopure(red) |
| Red 7038C | | | |
| Geoglit Silver | coated polyester glitter flakes | Silver glitter | Geoglit Silver |
| 004 HEX | | | |
| Wacker AK5 | Polydimethylsiloxane (PDMS) | Anti-tack or release | AK5 |
| | | agent, Mw ca. 600 | |
| Wacker AK10 | Polydimethylsiloxane (PDMS) | Anti-tack or release | AK10 |
| | | agent, Mw ca. 1100 | |
| Wacker | Hydroxyterminated PDMS | Anti-tack or release | CDS100 |
| CDS100 | | agent, Mw ca. 4300 | |
| Wacker C2T | Hydroxyterminated PDMS | Anti-tack or release | C2T |
| | | agent, Mw ca. 20000 | |

### Example 1.—Polyester Homo-Polymers and Co-Polymers

Melting temperature as a function of lactide content (Table 4) was investigated and temperature of the polymer samples was controlled by aid of a hot stage. Visual observation was used to determine the melting temperature and was taken as the temperature when the polymer matrix went from opaque/white to transparent/translucent, and from solid to malleable.

A first observation is low molecular weight of the (homo) polymer appears to reduce the melting temperature.

Lactide-content in copolymers was extended to include non-commercial samples to investigate melting temperatures in a wider lactide content range. Batch variations were substantial and rendered scattered data, and melting point temperature varies between different manufacturing batches with the same lactide content. As a rough general observation, the melting temperature of poly(caprolactone-co-lactide) polymers trends downwards with about 1 C per % lactide in the copolymer. The depression in melting temperature with lactide content quickly levels off and the lowest melting temperatures observed were in the range 40° C. to 45° C. The caprolactone homopolymer has a melting temperature of ca. 60° C. and polylactide homopolymer of about 170° C. Melting temperature of the copolymer as a function of lactide content therefore passes via a minimum.

TABLE 4
Homo- and co-polymers with varying lactide content from 0 to 15%.

| | | | | Polymer melt | |
|---|---|---|---|---|---|
| | | | | flow index | |
| Commercial | Chemical name/ | Monomer | Polymer melting | (MFI)/Mw | |
| name | description | ratio | temperature | (kD) | Abbreviation |
| Ingevity | polycaprolactone | PCL/PLA | ca. 60° C. | 7/50 | PCL(high |
| CAPA6500 | | (100/0) | | | Mw) |
| Ingevity | polycaprolactone | PCL/PLA | Batch variations | 9/25 | PCL(low |
| CAPA6250 | | (100/0) | ca. 50° C. to 60° C. | | Mw) |
| Ingevity | poly(caprolactone- | PCL/PLA | Batch variations | — | PCL(90)-co- |
| CAPA8502A | co-lactide) | (90/10) | down to 40° C. | | PLA(10) |
| N/A | poly(caprolactone- | PCL/PLA | Batch variations | — | PCL(88)-co- |
| | co-lactide) | (88/12) | down to 40° C. | | PLA(12) |
| N/A | poly(caprolactone- | PCL/PLA | Batch variations | — | PCL(85)-co- |
| | co-lactide) | (85/15) | down to 40° C. | | PLA(15) |

### Example 2.—Softeners

Thirteen different softeners were tested and melting temperature and material properties for PCL homopolymer-based mixtures were evaluated, Table 5.

At a 40% wt addition the best softeners appeared to be Benzoflex 988 and Benzoflex 2088 as judged from melting point depression and mechanical properties combined. Benzoflex 988 or Benzoflex 2088 was evaluated at higher contents (50% and 60%). Indeed, melting temperature was further decreased (41° C. and 37° C.). Despite the higher addition levels the mechanical properties in the solid state are acceptable for PCL (high Mw), while samples prepared with PCL (low Mw) are more clearly affected in a negative way with a softer and more brittle matrix in the solid state and more sticky properties in the molten state.

Based on results in Table 5, and as a possible alternative, was a mixture of 50% CAPA 6500D (high MW polycaprolactone), 40% Benzoflex 988, and 10% Edenol1200 evaluated. It was found the melting temperature was about 44° C. and the material properties were suboptimal. Thus, pure Benzoflex 988 appears to be a better choice than combining otherwise two promising softeners in this case.

TABLE 5
Solvents from various suppliers/manufacturers were blended
(40%) with PCL(high Mw) (60%). After solidification,
the meting temperature was evaluated on a hot stage
and material properties subjectively evaluated.

| | Melting | |
|---|---|---|
| | temperature/ | |
| Softener | ° C. | Observations |
| Benzoflex 2088 | 45 | Tough and strong. Can be bent. |
| Benzoflex 988 | 45 | As for 2088. |
| Eastman TXIB | 49 | Strong, but snaps when bent. |
| Edenol102 | 47 | Not so strong, and not tough. Breaks |
| | | easily. Grainy texture. |
| Edenol1212 | 48 | Strong and tough. |
| Edenol1215 | 50 | Tough, but can be bent more easily as |
| | | compared to 1212. |
| Edenol DBS | 48 | Like Edenol 102 - not so good. |
| Edenol1200 | 50 | Very strong - almost as without solvent. |
| Edenol D81 | 50 | Like Edenol 102 and DBS. Not so good, |
| | | and with oily surface. |
| SnS | 48 | Like Edenol D81 |
| Eastman168 | 48 | Rather strong and tough - like |
| | | Edenol 1215 |
| I20 | 51 | Strong and tough but on the verge to |
| | | separate, and somewhat oily surface. |
| Eastman | 47 | Dry, but somewhat brittle |
| TEG-EH | | |

### Example 3.—Polymer/Softener Optimisation

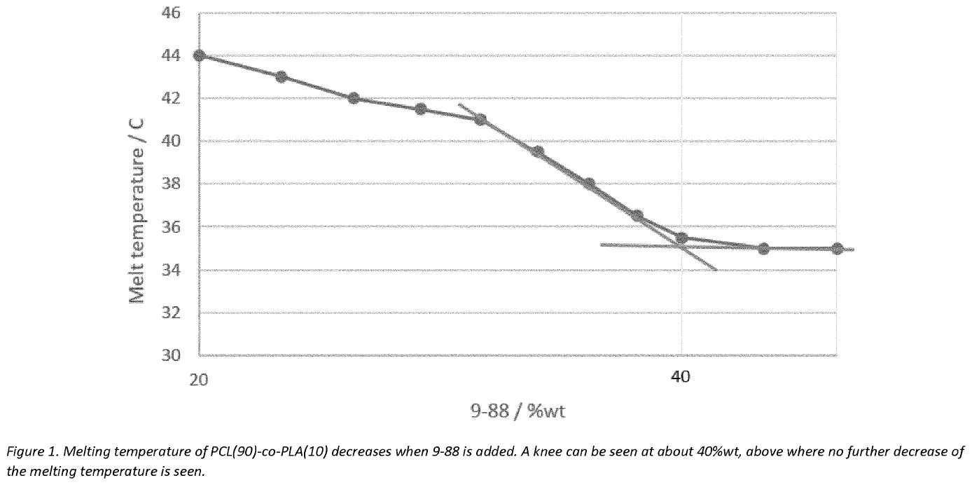

Based on results in Examples 1 and 2 the melting temperature variation was investigated and optimized for PCL (90)-co-PLA (10) upon addition of Benzoflex 988. Samples were prepared by melting and mixing polymer and softener. Transformation of the solid sample opaque/white to transparent/translucent, and from solid to malleable, defined the melting temperature and was determined by using a hot stage. FIG. 1 shows a strong decrease up to about 40 wt % Benzoflex 988 after which the melting temperature of the mixture flattens out at about 35° C.

A similar behavior is found for PCL (high Mw) homopolymer were melting temperature is 60° C., 45° C., 41° C., 37° C., 37° C. for the sequence 0 wt %, 40 wt %, 50 wt %, 60 wt %, and 64 wt % Benzoflex 988.

Addition of Benzoflex 988 appears to be a convenient and reproducible way to provide mixtures with an optimal melting temperature of about 35° C. to 37° C. In this way the ‘simpler’ homopolymer can be used instead of the more complicated copolymers, also when melting temperatures around body temperature is desired.

### Example 4.—Filled Compositions

Four different modelling compounds were prepared with polymer PCL (88)-co-PLA (12), Table 6. The melting temperature was depressed and controlled to about 39° C. by a balanced addition of softener (Blend 1).

Microlene requires ca.85° C. to be dispersed properly. To prepare Blend 2 start by mixing PCL (88)-co-PLA (12) and Microlene (blue) at ca. 85° C. Add Benzoflex 988, and when mixed properly add lokalit A followed by AK5.

To prepare Blend 3 a lower temperature can be used. Mixing can be achieved at temperatures just above melting temperature of the polymer. PCL (88)-co-PLA (12), Lysopure (red), and Benzoflex 2088 was mixed at a temperature of about 50° C. Then lokalit A was added followed by Geoglit Silver and AK5.

Blend 4 contains substantially more filler, while mixing follows the same preparation sequence as for Blend 3.

The resulting modelling compounds can be formed and sculptured by hand at working temperatures above their melting temperature of about 39° C. The materials settle and solidify in normal room temperature conditions. Blend 4 has a less expensive formula because it contains more inexpensive filler. A higher filler content comes with a more brittle and less flexible solidified compound.

TABLE 6
Recipes for four modelling compounds filled with a
small sized inorganic filler (Iokalit A - CaCO₃).

| Raw material | Blend 1 | Blend 2 | | Blend 3 | | Blend 4 | |
|---|---|---|---|---|---|---|---|
| PCL(88)-co-PLA(12) | 69% wt | 41% | wt | 40.6% | wt | 26% | wt |
| Lysopure(red) | — | — | | 0.2% | wt | — | |
| Microlene(blue) | — | 0.5% | wt | — | | — | |
| GWT(green) | — | — | | — | | 1% | wt |
| Geoglit Silver | — | — | | 1% | wt | — | |
| Benzoflex 988 | 31% wt | 18% | wt | 18% | wt | 12% | wt |
| Iokalit A | — | 35% | | 34.7% | | 57% | wt |
| AK5 | — | 5.5% | wt | 5.5% | wt | 4% | wt |

### Example 5.—Use of Sand Fillers of Various Grades

Sand of various sizes can be used to obtain modelling compounds, Table 7. Ratio between PCL (high Mw) and Benzoflex 988 was optimized to provide a balance between physical properties (strength of compound in the solid form) and melting temperature (37° C.), Blend 5. Blend 6, Blend 7, and Blend 8 all have a melting temperature of about 37° C. above which they can be conveniently shaped by hand. At lower temperature the materials settle and solidify. By repeating the temperature cycle the materials can be reshaped to new solid objects. Due to the different sizes of the sand grains the texture of the materials vary from ‘soft and smooth’ to more ‘rough and grainy’.

The commercial sand raw materials had to first be surface treated to be suitable to use together with the binder. First an aqueous dispersion containing two silanes was prepared: A mix of silanes Wacker Geniosil XL10 (4.5 g) and Wacker Silres 1701 (0.5 g) was added to an aqueous solution of 94.5 g water and 0.5 g HAc (24%) under vigorous stirring to provide a course dispersion. Mixing (vigorous) continued for ca. 30-60 min. In the meantime, sand GA39, M32, or B55 was heated to some 55-60° C. in a stainless-steel pot. The aqueous silane dispersion (100 g) was added to the hot sand under continuous mixing. Mixing continued until water had evaporated and the sand was dry. This process provided surface treated sand samples GA39 (ST), M32 (ST), or B55 (ST), which were used as fillers.

TABLE 7
Recipes for four modelling compounds filled
with sand filler of various sizes.

| Raw material | Blend 5 | Blend 6 | | Blend 7 | | Blend 8 | |
|---|---|---|---|---|---|---|---|
| PCL(high Mw) | 36% wt | 5.4% | wt | 5.4% | wt | 5.4% | wt |
| Benzoflex 988 | 64% wt | 9.6% | wt | 9.6% | wt | 9.6% | wt |
| GA39(ST) | — | 84 | wt % | — | | — | |
| M32(ST) | — | — | | 84 | wt % | — | |
| B55(ST) | — | — | | — | | 84 | wt % |
| AK10 | — | 1% | wt | 1% | wt | 1% | wt |

### Example 6.—Compositions with Expanded Polymer Fillers

(Expanded) polymer fillers of various sizes can be used to obtain filled modelling compounds, Table 8. The ratio between PCL (high Mw) and Benzoflex 988 was the same as in Example 5 to provide a melting temperature of about 37° C. Above this temperature the modelling compounds in Table 8 can be conveniently shaped by hand. At lower temperature the materials settle and solidify. By repeating the temperature cycle the materials can be reshaped to new solid objects. Due to the different sizes of the filler the texture of the materials varies. Since the fillers have voids or are hollow Blend 9 and Blend 10 are soft/elastic in texture. Blend 11 has a higher binder to filler ratio and the texture of the material in the solid state more resembles that of a plastic material.

TABLE 8
Recipes for four modelling compounds filled with
expended polymer based fillers of various sizes.

| Raw material | Blend 9 | Blend 10 | | Blend 11 | |
|---|---|---|---|---|---|
| PCL(high Mw) | 33% wt | 30% | wt | 35% | wt |
| Lysopure(red) | — | — | | 0.2% | wt |
| Benzoflex 988 | 59% wt | 54% | wt | 62% | wt |
| E-PLA | 8% wt | — | | — | |
| Expancel 461 DE | — | 15 | wt % | 1.5 | wt % |
| AK10 | — | 1% | wt | 1.3% | wt |

### Example 7.—Compositions with Polymer Fillers & In-Situ Expansion

Heating Expancel 461 DU to temperatures around 100° C. results in that the filler polymer shell softens. The incorporated blowing agent gives an expansion to provide particles resembling Expancel 461 DE.

A mixture of 63% wt PCL (low Mw), 27% wt Benzoflex 988, and 10% wt Expancel 461 DU was prepared by first mixing PCL (low Mw) and Benzoflex 988 at about 65° C., then Expancel 461 DU was mixed in. The PCL-based binder of the material melts at temperatures of about 50° C. and the material becomes malleable.

When a small lump of the solid material containing Expancel 461 DU is contacted with boiling water, first the PCL (low Mw)-based binder melts, and then the blowing agent expands the filler particles in situ after their polymer shell has softened due to the elevated temperature. The final material is a lightweight material with properties much resembling those of the similar material prepared with the pre-expanded Expancel 461 DE. The low Mw PCL-polymer was initially chosen because a high melt flow index (MFI) facilitates in situ expansion of Expancel. The disadvantage from a low Mw is a material stickier to hands and surroundings when in the molten stage.

A similar preparation was made with PCL (high Mw): 63% wt PCL (low Mw), 27% wt Benzoflex 988, and 10% wt Expancel 461 DU. Just like the mixture based on the polymer with the low molecular weight this preparation also expands in hot water despite the lower MFI. Both formed effective compositions.

### Example 8.—Use of Two Types of Filler

A filler with a small size can be incorporated in the binder system with a limited (essentially negligible) effect on the final materials properties. In Blend 13 has HDK H2000 been used to reduce the amount PCL (high Mw) and Benzoflex 988 by 25 wt % (from 6% wt to 4.5% wt, and from 9% wt to 6.7% wt). This is an effective way to reduce expensive polymer content without affecting the material properties too much.

TABLE 9
Recipes for two modelling compounds filled with sand M32(ST)

| Raw material | Blend 12 | Blend 13 | |
|---|---|---|---|
| PCL(high Mw) | 6% wt | 4.5% | wt |
| Benzoflex 988 | 9% wt | 6.7% | wt |
| HDK H2000 | — | 3.8% | wt |
| M32(ST) | 85% wt | 85% | wt |

### Example 9—Use of Carbonates as Softeners

Although DMC would appear to be a suitable softener as it can easily be mixed with PCL (high Mw) when melted at all evaluated proportions (up to 50%), its compatibility is hindered by its low boiling point and concomitant high vapour pressure. This leads to a rapid loss of DMC, especially when heated. However, PC has a much higher boiling point than DMC and thus is a more attractive alternative. After mixing the PC softener with the PCL (high Mw) in the molten phase, the mixtures were either cooled such that they rapidly solidified or cooled slowly so that solidification took place over a longer time period. The various mixtures melting temperatures were evaluated by the aid of a hot stage and an infrared thermometer.

TABLE 10
The melting point after rapid cooling and observations
after slow cooling for the resulting mixture comprising
various ratios of PCL and PC.

| | | Melting temper- | Observation after |
|---|---|---|---|
| | | ature | slow cooling |
| PCL(high | PC/% | after rapid | (melting |
| Mw)/% wt | wt | cooling/° C. | temperature) |
| 100 | 0 | 59 | |
| 98 | 2 | 53 | |
| 96 | 4 | 52 | |
| 92 | 8 | 48 | |
| 83 | 17 | 46 | |
| 67 | 33 | 42 | |
| 58 | 42 | 40 | Leakage/sweating of |
| | | | PC (40 C.) |
| 50 | 50 | 37 | Grainy texture (37 C.) |
| 33 | 67 | 28 | Grainy texture (35 C.) |

Slow cooling seems to induce separation of a minor portion of the solvent at high ratios, which is reflected as sweating and a grainy texture and as a higher melting temperature of the ‘33/67’—sample as compared to when this sample was cooled rapidly.

### Example 10—Softener Mixtures for PCL Polymers in Mouldable Compositions

It is additionally possible to combine different softeners in the mouldable composition. Table 11 reports compositions comprising both PC and Benzoflex 988, wherein the two softeners were melted and mixed to a homogeneous mixture. The Expancel 461 DE, lokalit A and AK5 were added to the mixture and blended to a homogenous mouldable composition.

TABLE 11
Mouldable compositions comprising two different softeners

| PCL | Benzoflex 988 | PC | Expancel | lokalit | | |
|---|---|---|---|---|---|---|
| (high Mw) | (softener) | (softener) | 461 DE | A | AK5 | Comment |
| 17.1 | 25.6 | 1.35 | 0.37 | 49.7 | 5.9 | 5% of softener is PC |
| 16.8 | 25.2 | 2.8 | 0.37 | 49.0 | 5.9 | 10% of softener is PC |
| 16.8 | 14.0 | 14.0 | 0.37 | 49.0 | 5.9 | 50% of softener is PC |

All three compositions were evaluated by melting in a pot of water at 39° C. followed by cooling to room temperature and solidification. The process was repeated ca. 10 times. The ‘5%-sample’ and the ‘10%-sample’ had stable properties, while there was a change with the number of cycles for the ‘50%-sample’ and eventually this did not melt at 39° C. This may reflect a compositional change due to loss of PC based on the rather high solubility in water of this softener.

### Example 11—Loss of Softener in Mixture with PCL Polymers

A PCL (high Mw)/PC mixture (33%/67%) was prepared by melting and mixing and a cube (0.88 g) was formed and solidified by lowering the temperature. Depending on if cooling is rapid or slow this ‘33/67’-material may have a variation in the perceived melting temperature but is low and about 30° C. (Example 9).

The solid cube was contacted with excess water (25° C.) for 6 days, and then left resting in air for another 7 days. After this treatment the melting temperature of the material had increased to ca. 60° C. and about that of pure PCL (high Mw) (i.e. a ‘100/0’-material).

This example demonstrates that loss of a water-soluble softener can be used to increase the melting temperature and act as a solidification/hardening mechanism of a formed object. PC has a rather high boiling point and low vapor pressure and there is no high loss of softener by evaporation. PCL/PC mixture is expected to be storage stable before contact with water. A PCL (high Mw)/DMC mixture is for this reason less favourable since it ‘ages’ when exposed to air due to lower boiling point (and higher vapour pressure) compared to that of PC.

### Example 12—Surface Treatment of Sand Filler Material

Highly suitable surface-modified sand may be formed by treatment of sand or other silica-containing fillers with alkoxy silanes or silyl alkanoates at 0.05 to 0.2% by weight of the filler.

TABLE 12
Materials

| Raw | | Abbre- | | Character- |
|---|---|---|---|---|
| material | Supplier | viation | Composition | istics |
| Geniosil | Wacker | XL10 | trimethoxyvi- | |
| XL10 | Chemie | | nylsilane | |
| | AG | | | |
| Silres | Wacker | BS1701 | Triethoxy(2,4,4- | |
| BS1701 | Chemie | | trimeth- | |
| | AG | | ylpentyl)silane | |
| Acetic acid | Local | HAc(24%) | 24% acetic acid | |
| (24%) | supermar- | | in aqueous | |
| | ket | | solution | |
| Sand | Sibelco | GA39 | 98.8% SiO2 | Specific weight |
| GA39 | | | | 1500 kg/m3 · |
| | | | | d50 ca. 91 |
| | | | | micrometer |
| Sand | Sibelco | B15 | 90.5% SiO2 | Specific weight |
| B15 | | | 4.9% Al2O3 | 1500 kg/m3 · |
| | | | | d50 ca. 130 |
| | | | | micrometer |
| Sand | Sibelco | Mam1s | 99.8% SiO2 | Specific weight |
| Mam1s | | | | 1500 kg/m3 · |
| | | | | d50 ca. 205 |
| | | | | micrometer |

The process time in production scale is largely dependent on the time it takes to evaporate the water that stems from the added silane solution/dispersion. For this reason, it is advantageous to minimize the water needed by increasing the concentration of silane in the aqueous solution/dispersion, without jeopardizing the result of the surface treatment.

Mam1s sand was heated in a jacketed steam-heated mixer to 55-60° C. The batch sizes were 400 kg at production scale.

Coarse aqueous silane dispersions were prepared by vigorous mixing for 30-60 minutes. Acetic acid was used to adjust pH value to approximately 4, where silane reaction is at minimum. This provides a dispersion where silanes do not react before they meet silanol-groups on the surfaces of the sand grains and the aqueous phase is evaporated.

The dispersion was then added to the pre-heated sand and mixing continued until the water had evaporated. The treatment was assumed to be completed when the sand is dry. The processing time in large-scale production is around 5-30 minutes (varying according to the amount of water used in the dispersion).

Table 13 presents the compositions of silane dispersion for 400 kg testing. These two versions of silane dispersion are 5% wt and 11% wt, respectively, and give good results of the sand properties as evaluated by the method described below. Version B is recommended in large-scale production because it contained less silane (XL10 and BS1701) and water and required less processing time. Water content was reduced by 74% in comparison with Version A, and modification degree was decreased from 17 mg per m2 to 9 mg per m2.

TABLE 13A
Version A

| Component | For 400 kg Batch (g) | Composition (wt %) |
|---|---|---|
| XL10 | 375 | 4.5% |
| BS1701 | 42 | 0.5% |
| HAc (24%) | 42 | 0.5% |
| Water | 7875 | 94.5% |
| Total | 8334 | 100% |
| Silane/sand ratio (%) | 0.10% | |
| Water/sand ratio (%) | 1.97% | |

TABLE 13B
Version B

| Component | For 400 Kg Batch (g) | Composition (wt %) |
|---|---|---|
| XL10 | 188 | 9.9% |
| BS1701 | 21 | 1.1% |
| HAc (24%) | 21 | 1.1% |
| Water | 1667 | 87.9% |
| Total | 1896 | 100% |
| Silane/sand ratio (%) | 0.05% | |
| Water/sand ratio (%) | 0.42% | |

Properties of the treated sand were judged by contacting the sand with pure water. Modification was confirmed by increased hydrophobicity of the particles. This was evaluated by contacting the sand with water to subjectively judge wetting properties and contact angle. It could either be that sand was spread on a flat surface and a drop of water was placed on top of the sand. The surface modification was judged successful if the water stayed as a drop/lens on top of the sand without wetting the sand. An alternative method is to pour modified/treated sand into a large volume of water. Treatment is judged successful if the immersed sand lumps and is not wetted by the water, or alternatively if sand grains are small (approx. 100 micrometer or less), they may float on the water surface. A suboptimal treatment is characterized by that the sand is wetted by water, it does not lump, and small sand grains sink.

1. A composition comprising;
a) at least one polyester homopolymer or copolymer having a melting point of 40 to 70° C.; and
b) at least one softener having a molecular weight of 50 to 500 amu;
wherein the composition exhibits a melting point or softening point within the range of 30-45° C.; component a) is present at 25 to 95% by weight of components a) and b); and
component b) is present at 5 to 75% by weight of components a) and b).

2. The composition of claim 1 additionally comprising;
c) at least one filler.

3. The composition of claim 1, wherein the at least one polyester homopolymer or copolymer comprises at least one homopolymer or copolymer of caprolactone.

4. The composition of claim 1, wherein the at least one polyester homopolymer or copolymer comprises at least one copolymer of caprolactone and lactide.

5. The composition of claim 1, wherein the at least one polyester homopolymer or copolymer comprises at least one homopolymer or copolymer of caprolactone having a mean molecular weight of 10,000 to 120,000.

6. The composition of claim 1, wherein the softener comprises at least one alcohol, at least one carbonyl; at least one ether; at least one organic acid, at least one halogen, at least one nitro and/or at least one aromatic moiety.

7. The composition of claim 1, wherein the softener comprises at least one benzyl alcohol, benzyl ester, benzyl ether and/or benzoic acyl moiety, optionally substituted with a least one alcohol, at least one carbonyl, at least one ether, at least one organic acid, at least one halogen, and/or at least one nitro moiety.

8. The composition of claim 1, wherein said softener comprises at least one compound of formula (i) 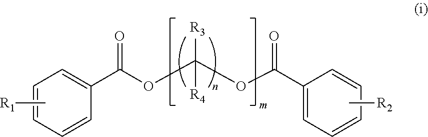
wherein:
each of R₁ and R₂ is independently selected from H; Cl; F; Br; NO₂; CH₃; C₂ to C₈ branched or straight chain alkyl or alkenyl groups;
each of R₃ and R₄ is independently selected from H; Cl; F; Br; CH₃; C₂ to C₈ branched or straight chain alkyl or alkenyl groups;
m is an integer value between 1-10;
and n is an integer value between 1-10;

9. The composition of claim 8 wherein:
each of R₁ and R₂ is independently selected from H; CH₃; C₂ to C4 branched or straight chain alkyl or alkenyl groups; and mixtures thereof;
each of R₃ and R₄ is H;
m is an integer value between 2-3; and
n is an integer value between 2-3.

10. The composition of claim 6 wherein the carbonyl moiety is a carbonate ester.

11. The composition of claim 1, wherein said softener comprises at least one carbonate ester compound selected from:
C2 to C12 cyclic carbonates;
linear alkyl carbonates of formula R₅—O—CO—O—R₆ where R₅ and R₆ are independently C1 to C12 linear branched alkyl groups;
aryl carbonates of formula R₇—O—CO—O—R₈ where R₇ and R₅ are independently C5 to C10 aryl or heteroaryl groups; and
C2-C12 dialkyl dicarbonates.

12. The composition of claim 2, wherein component c) comprises a sand filler, a glass filler, a polymer filler, a mineral filler or mixtures thereof.

13. The composition of claim 2, wherein component c) comprises at least one surface-treated filler.

14. The composition of claim 13 wherein said surface treatment is a hydrophobic surface treatment.

15. The composition of claim 13, wherein the surface treatment is a treatment with at least one alkoxy silane and/or at least one silyl alkanoate.

16. The composition of claim 12, wherein said polymer filler comprises a filler selected from polystyrene beads, polyolefin beads, polyester beads, polyamide beads, expanded polystyrene beads, and mixtures thereof;

17. The composition of claim 2, comprising component c) in an amount of 10 to 95% by weight of components a) and b) and c).

18. The composition of claim 1, further comprising:
d) at least one silicone oil.

19. The composition of claim 1, further comprising at least one component selected from:
e) a pigment;
f) a glitter;
g) a mica or coated mica;
h) a perfume; and
i) a preservative.

20. A modelling compound comprising at least one composition as claimed in claim 1.

21. A method for the formation of a composition as claimed in claim 1, comprising:
I) heating component a) to a temperature of 30 to 70° C.,
II) mixing in component b);
III) optionally mixing in components c) and/or components d)-h) where present; and
IV) cooling the resulting mixture to ambient temperature;
wherein steps I), II) and III) may take place sequentially or simultaneously.

22. The method of claim 21 comprising heating and mixing components a) and b) together at above the melting temperature of component a) followed by mixing in components c) and/or components d)-h) where present and cooling to ambient temperature.

23. The method of claim 22 wherein component c) is present, the method comprising mixing component c) with component b) followed by heating and mixing in component a) and cooling to ambient temperature.

24. A method of forming a 3-dimensional shape comprising:
i) Warming a composition as claimed in claim 1 in water wherein the water is at a temperature of no greater than 42° C.;
ii) Forming the composition into the desired shape; and
iii) Cooling the composition.

25. The composition of claim 2, further comprising:
d) at least one silicone oil.

26. The composition of claim 2, further comprising at least one component selected from:
e) a pigment;
f) a glitter;
g) a mica or coated mica;
h) a perfume; and
i) a preservative.

27. A modelling compound comprising at least one composition as claimed in claim 2.

28. A method of forming a 3-dimensional shape comprising:
i) warming a composition as claimed in claim 2 in water, wherein the water is at a temperature of no greater than 42° C.;
ii) forming the composition into the desired shape; and
iii) cooling the composition.
